(19) United States
(12) Patent Application Publication
(10) Pub. No.: US 2026/0171940 A1
(43) Pub. Date: Jun. 18, 2026

(54) CURRENT ESTIMATION USING KALMAN FILTER FOR MOTOR CONTROL

(71) Applicant: Steering Solutions IP Holding Corporation, Saginaw, MI (US)

(72) Inventors: Taibin Wang, Suzhou (CN); Yaoqi Wang, Suzhou (CN); Jason Ren, Suzhou (CN); Juguang Qiang, Suzhou (CN); Yongfei Liu, Suzhou (CN)

(21) Appl. No.: 18/986,125

(22) Filed: Dec. 18, 2024

(30) Foreign Application Priority Data
Dec. 13, 2024 (CN) 2024118365634

(51) Int. Cl. H02P 21/13; H02P 21/14

(52) U.S. Cl. CPC H02P 21/13; H02P 21/14

(57) ABSTRACT

A method of operating a motor control system for a brushless direct current (BLDC) motor includes: receiving a current command signal; measuring a measured phase current for two or more phases of a plurality of phases of the BLDC motor; determining an estimated motor current based on the measured phase current; determining, using a Kalman filter, a modified feedback current signal based on the estimated motor current; determining a current difference signal as a difference between the current command signal and the modified feedback current signal; determining a voltage command based on the current difference signal; and operating a plurality of switches in an inverter to selectively conduct current and to thereby apply a voltage to the BLDC motor in accordance with the voltage command.

### CROSS REFERENCE TO RELATED APPLICATION

This application claims the benefits of priority to Chinese Patent Application No. 2024118365634, filed Dec. 13, 2024, the disclosure of which is incorporated by reference herein in its entirety.

### TECHNICAL FIELD

This disclosure relates to control techniques for improving estimations of motor current based on a measurement of two or more phase currents and for controlling a multi-phase motor.

### BACKGROUND

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

Brushless DC (BLDC) motors have a variety of applications. One such application is for providing a steering torque in an EPS system or a SbW steering system.

An inverter may supply power to the windings of a BLDC motor and be controlled based on two or more measured phase currents. In some cases, current is measured on only one leg of a phase driver, such as on a low-side leg. Under certain operating conditions, such as a sufficiently high duty cycle, there may be insufficient time to obtain a reliable phase current based on such a measurement of current on only two legs of a phase drive. Techniques such as Kirchhoff's Current Law (KCL) may be used to estimate the phase current based on other measured currents. However, such estimation of phase current can cause increased noise, especially at a 12^{th} harmonic.

### SUMMARY

An aspect of the disclosed embodiments includes a method of operating a motor control system for a brushless direct current (BLDC) motor. The method includes: receiving a current command signal; measuring a measured phase current for two or more phases of a plurality of phases of the BLDC motor; determining an estimated motor current based on the measured phase currents; determining, using a Kalman filter, a modified feedback current signal based on the estimated motor current; determining a current difference signal as a difference between the current command signal and the modified feedback current signal; determining a voltage command based on the current difference signal; and operating a plurality of switches in an inverter to selectively conduct current and to thereby apply a voltage to the BLDC motor in accordance with the voltage command.

Another aspect of the disclosed embodiments includes a motor control system for a brushless direct current (BLDC) motor having a plurality of stator windings and defining a plurality of phases. The motor control system includes: a DC power supply, an inverter, two or more phase current sensors, and a controller. The DC power supply includes a DC high node and a DC low node, wherein the DC low node and the DC high node have a DC voltage therebetween. The inverter has a plurality of phase drivers each configured to apply a DC power to a corresponding stator winding of the plurality of stator windings via an output node connected to the BLDC corresponding stator winding, wherein each phase driver of the plurality of phase drivers includes: a high-side switch configured to selectively conduct current between the DC high node and the output node, and a low-side switch configured to selectively conduct current between the output node and the DC low node. The two or more phase current sensors are each configured to determine a measured phase current in a corresponding phase driver of the plurality of phase drivers. The controller is configured to: determine an estimated motor current based on the measured phase current; determine, using a Kalman filter, a modified feedback current signal based on the estimated motor current; determine a current difference signal as a difference between a current command signal and the modified feedback current signal; determine a voltage command based on the current difference signal; and send a command to the inverter to cause the high-side switch and the low-side switch of the plurality of phase drivers to each selectively conduct current and to thereby apply a voltage to the BLDC motor in accordance with the voltage command.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 shows a schematic diagram of an electric power steering (EPS) system according to the principles of the present disclosure.

FIG. 2 presents a block diagram of a brushless DC (BLDC) motor drive system according to the principles of the present disclosure.

FIG. 3 shows a schematic diagram of a motor drive system for operating a brushless direct current (BLDC) motor, according to the principles of the present disclosure.

FIG. 4 shows a graph illustrating noise generated by the BLDC motor drive system as a function of speed of rotation of the BLDC motor and showing 12^{th} and 24^{th} harmonic noise.

FIG. 5 shows a schematic block diagram of a traditional current controller for a BLDC motor drive system.

FIG. 6 shows a schematic block diagram of a current control loop for a BLDC motor drive system, with a Kalman filter, according to the principles of the present disclosure.

FIG. 7A shows a graph illustrating noise generated by the BLDC motor drive system as a function of speed of rotation of the BLDC motor and without the Kalman filter being enabled.

FIG. 7B shows a graph illustrating noise generated by the BLDC motor drive system as a function of speed of rotation of the BLDC motor and with the Kalman filter being enabled.

FIG. 7C shows a graph illustrating noise generated by the BLDC motor drive system as a function of speed of rotation of the BLDC motor and with the Kalman filter being enabled and tuned to compensate for the 24^{th} harmonic noise.

FIG. 8 shows a flow diagram listing steps in a method of operating a motor control system for a brushless direct current (BLDC) motor, according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electric power steering system (EPS) system, an SbW steering system, a hydraulic steering system, or other suitable steering system. The steering system of such a vehicle typically controls various aspects of vehicle steering including providing steering assist to an operator of the vehicle, controlling steerable wheels of the vehicle, and the like.

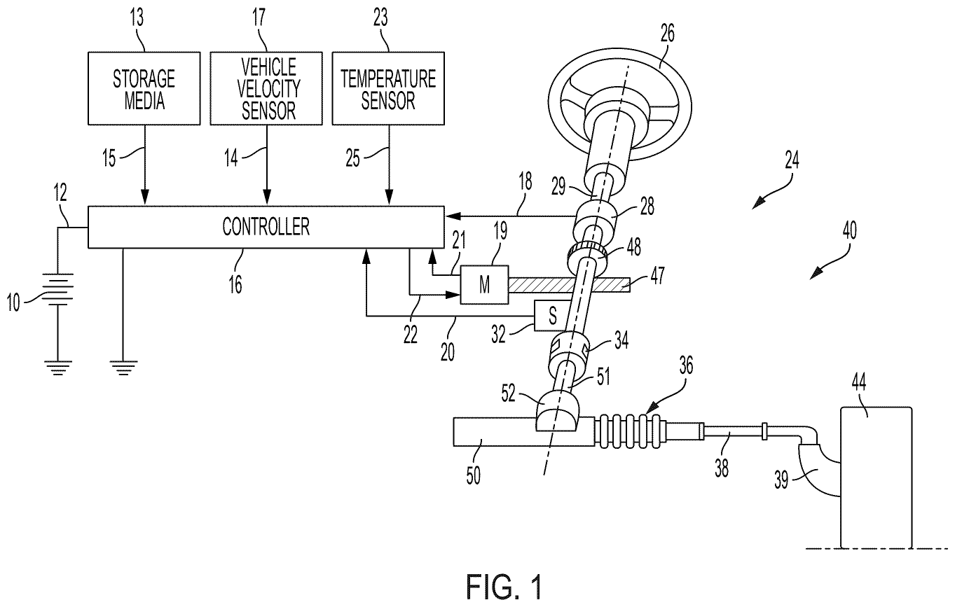

FIG. 1 is a schematic diagram of an EPS system 40 suitable for implementation of the disclosed techniques. The EPS system 40 includes a steering mechanism 36, which includes a rack-and-pinion type mechanism having a toothed rack (not shown) within housing 50 and a pinion gear (also not shown) located under gear housing 52. As the operator input, hereinafter denoted as a steering wheel 26 (e.g. a handwheel and the like), is turned, the upper steering shaft 29 turns and the lower steering shaft 51, connected to the upper steering shaft 29 through universal joint 34, turns the pinion gear. Rotation of the pinion gear moves the rack, which moves tie rods 38 (only one shown) in turn moving the steering knuckles 39 (only one shown), which turn a steerable wheel(s) 44 (only one shown).

Electric power steering assist is provided through the steering motion control system 24 and includes a steering electronic control unit (ECU) 16 and an electric motor 19. The steering ECU 16 is powered by the vehicle power supply 10 through supply conductors 12. The steering ECU 16 receives a vehicle speed signal 14 representative of the vehicle velocity from a vehicle velocity sensor 17. Steering angle is measured through position sensor 32, which may be an optical encoding type sensor, variable resistance type sensor, or any other suitable type of position sensor, and supplies to the steering ECU 16 a position signal 20. Motor velocity may be measured with a tachometer, or any other device, and transmitted to the steering ECU 16 as a velocity signal 21. A motor velocity denoted ωₘ may be measured, calculated or a combination thereof. For example, the motor velocity ωₘ may be calculated as the change of the motor position as measured by a position sensor 32 over a prescribed time interval. For example, motor speed ωₘ may be determined as the derivative of the motor position θₘ with respect to time. It will be appreciated that there are numerous well-known methodologies for performing the function of a derivative.

As the steering wheel 26 is turned, torque sensor 28 senses the torque applied to the steering wheel 26 by the vehicle operator. The torque sensor 28 may include a torsion bar (not shown) and a variable resistive-type sensor (also not shown), which outputs a torque signal 18 to the steering ECU 16 in relation to the amount of twist on the torsion bar. Although this is one type of torque sensor, any other suitable torque-sensing device used with known signal processing techniques will suffice. In response to the various inputs, the controller sends a command 22 to the electric motor 19, which supplies torque assist to the steering system through worm 47 and worm gear 48, providing torque assist to the vehicle steering.

It should be noted that although the disclosed embodiments are described by way of reference to motor control for electric steering applications, it will be appreciated that such references are illustrative only and the disclosed embodiments may be applied to any motor control application employing an electric motor, e.g., steering, valve control, and the like. Moreover, the references and descriptions herein may apply to many forms of parameter sensors, including, but not limited to torque, position, speed and the like. It should also be noted that reference herein to electric machines including, but not limited to, motors, hereafter, for brevity and simplicity, reference will be made to motors only without limitation.

In the steering motion control system 24 as depicted, the steering ECU 16 utilizes the torque, position, and speed, and like, to compute a command(s) to deliver the required output power. The steering ECU 16 is disposed in communication with the various systems and sensors of the motor control system. Steering ECU 16 receives signals from each of the system sensors, quantifies the received information, and provides an output command signal(s) in response thereto, in this instance, for example, to the electric motor 19. Steering ECU 16 is configured to develop the corresponding voltage(s) out of inverter (not shown), which may optionally be incorporated with steering ECU 16 and will be referred to herein as steering ECU 16, such that, when applied to the electric motor 19, the desired torque or position is generated. In one or more examples, the steering ECU 16 operates in a feedback control mode, as a current regulator, to generate the command 22. Alternatively, in one or more examples, the steering ECU 16 operates in a feedforward control mode to generate the command 22. Because these voltages are related to the position and speed of the electric motor 19 and the desired torque, the position and/or speed of the rotor and the torque applied by an operator are determined. A position encoder is connected to the steering shaft 51 to detect the angular position θ. The encoder may sense the rotary position based on optical detection, magnetic field variations, or other methodologies. Typical position sensors include potentiometers, resolvers, synchros, encoders, and the like, as well as combinations comprising at least one of the forgoing. The position encoder outputs a position signal 20 indicating the angular position of the steering shaft 51 and thereby, that of the electric motor 19.

Desired torque may be determined by one or more torque sensors 28, which transmit the torque signals 18 indicative of an applied torque. Such a torque sensor 28 and the torque signals 18 therefrom, as may be responsive to a compliant torsion bar, spring, or similar apparatus (not shown) configured to provide a response indicative of the torque applied.

In one or more examples, a temperature sensor 23 is located at the electric motor 19. Preferably, the temperature sensor 23 is configured to directly measure the temperature of the sensing portion of the electric motor 19. The temperature sensor 23 transmits a temperature signal 25 to the steering ECU 16 to facilitate the processing prescribed herein and compensation. Typical temperature sensors include thermocouples, thermistors, thermostats, and the like, as well as combinations comprising at least one of the foregoing sensors, which when appropriately placed provide a calibratable signal proportional to the particular temperature.

The position signal 20, velocity signal 21, and torque signals 18 among others, are applied to the steering ECU 16. The steering ECU 16 processes all input signals to generate values corresponding to each of the signals resulting in a rotor position value, a motor speed value, and a torque value being available for the processing in the algorithms as prescribed herein. Measurement signals, such as the above mentioned are also commonly linearized, compensated, and filtered as desired to enhance the characteristics or eliminate undesirable characteristics of the acquired signal. For example, the signals may be linearized to improve processing speed, or to address a large dynamic range of the signal. In addition, frequency or time based compensation and filtering may be employed to eliminate noise or avoid undesirable spectral characteristics.

In order to perform the prescribed functions and desired processing, as well as the computations therefore (e.g., the identification of motor parameters, control algorithm(s), and the like), steering ECU 16 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, steering ECU 16 may include input signal processing and filtering to enable accurate sampling and conversion or acquisitions of such signals from communications interfaces.

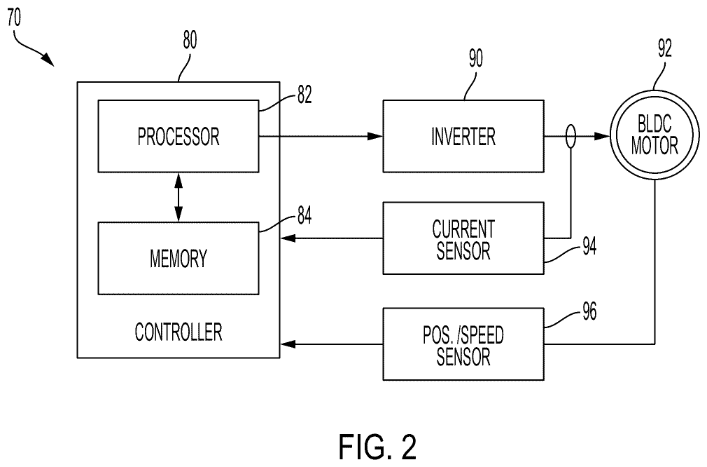

FIG. 2 is a block diagram of a brushless DC (BLDC) first motor drive system 70 according to the principles of the present disclosure. The first motor drive system 70 includes a BLDC motor 92, which may be a multi-phase machine having multiple sets of stator windings, each configured to conduct a DC current and to generate a torque. For example, the BLDC motor 92 may be a three-phase device having three sets of stator windings. However, the brushless DC motor 92 may have a different number of sets of stator windings. The BLDC motor 92 may be used as the electric motor 19 in the steering motion control system 24. Alternatively or additionally, the BLDC motor 92 may be used in another application.

The first motor drive system 70 includes a controller 80, such as an electronic control unit (ECU). The controller 80 may implement one or more functions of the steering ECU 16. controller 80 may be configured to control, for example, the various functions of the steering system and/or various functions of a vehicle. The controller 80 may include a processor 82 and a memory 84. The processor 82 may include any suitable processor, such as those described herein. Additionally, or alternatively, the controller 80 may include any suitable number of processors, in addition to or other than the processor 82. The memory 84 may comprise a single disk, a plurality of disks (e.g., hard drives) and/or an electronic non-volatile computer memory storage medium such as a Flash memory device. In some embodiments, memory 84 may include flash memory, semiconductor (solid state) memory or the like. The memory 84 may include Random Access Memory (RAM), a Read-Only Memory (ROM), or a combination thereof. The memory 84 may include instructions that, when executed by the processor 82, cause the processor 82 to, at least, control various aspects of the vehicle. Additionally, or alternatively, the memory 84 may include instructions that, when executed by the processor 82, cause the processor 82 to perform functions associated with the systems and methods described herein.

The controller 80 may be operably connected to an inverter 90. The inverter 90 may be configured to apply a DC output voltage V_{OUT} on one or more terminals connected to stator windings of the BLDC motor 92. The inverter 90 may generate the DC output voltage V_{OUT} based on a duty cycle command Duty_Cmd from the controller 80.

In some embodiments, and as shown in FIG. 2, the first motor drive system 70 may include two or more current sensors 94 configured to measure the current supplied to the BLDC motor 92 and to transmit a motor current signal to the controller 80, representing an actual motor current in a winding of the BLDC motor 92. Additionally or alternatively, and as also shown in FIG. 2, the first motor drive system 70 may include one or more position sensors 96 and configured to measure a rotational position of the BLDC motor 92 and to transmit a motor position signal ωₘ to the controller 80.

In some embodiments, the controller 80 may perform the methods described herein. However, the methods described herein as performed by the controller 80 are not meant to be limiting, and any type of software executed on a controller or processor can perform the methods described herein without departing from the scope of this disclosure. For example, a controller, such as a processor executing software within a computing device, can perform the methods described herein.

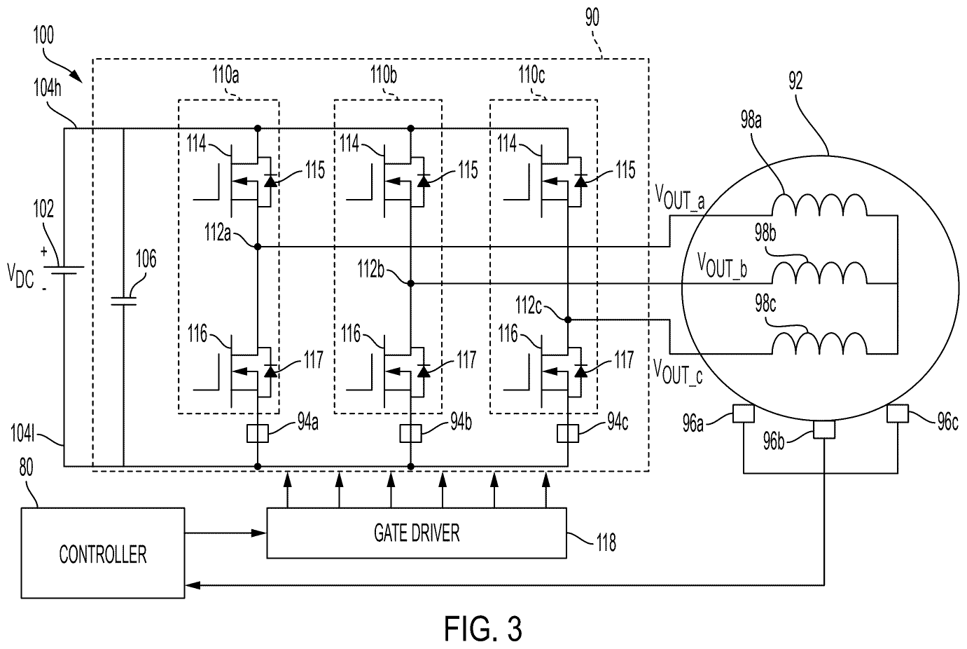

FIG. 3 shows a schematic diagram of a second motor drive system 100 for operating a brushless direct current (BLDC) motor 92. The second motor drive system 100 includes a DC power supply 102 having a DC high node 104h and a DC low node 104l and having a DC voltage V_{DC} therebetween. The DC power supply 102 is illustrated as a battery. However, the DC power supply 102 may have a different configuration, such as a DC/DC converter and/or a rectifier to provide the DC power from an AC source.

The second motor drive system 100 also includes the inverter 90 having an input capacitor 106 connected between the DC high node 104h and the DC low node 104l for regulating voltage thereacross. The inverter 90 also includes three phase drivers 110a, 110b, 110c. Each of the three phase drivers 110a, 110b, 110c receives the DC power from the DC power supply 102 and supplies output power to the BLDC motor 92 via a corresponding one of three output nodes 112a, 112b, 112c.

The three phase drivers 110a, 110b, 110c include an A-phase driver that generates a first DC power having an A-phase output voltage V_{OUT_a} on an A-phase output node 112a of the three output nodes 112a, 112b, 112c. The three phase drivers 110a, 110b, 110c also include a B-phase driver that generates a second DC power having a B-phase output voltage V_{OUT_b} on a B-phase output node 112b of the three output nodes 112a, 112b, 112c. The three phase drivers 110a, 110b, 110c also include a C-phase driver that generates a second DC power having a C-phase output voltage V_{OUT_c} on a C-phase output node 112c of the three output nodes 112a, 112b, 112c. Each of the three output nodes 112a, 112b, 112c is connected to a corresponding stator winding 98a, 98b, 98c of the BLDC motor 92. The BLDC motor 92 is shown as a three-phase device having three of the stator windings 98a, 98b, 98c with a wye connection. However, the BLDC motor 92 may have a different configuration, such as a delta connection of the stator windings 98a, 98b, 98c and/or a different number of the stator windings 98a, 98b, 98c.

Each of the three phase drivers 110a, 110b, 110c includes a high-side switch 114 configured to selectively conduct current between the DC high node 104h and a corresponding one of the three output nodes 112a, 112b, 112c. The high-side switches 114 may each include a metal-oxide-semiconductor field-effect transistor (MOSFET). However, other types of switching devices may be used, such as an insulated-gate bipolar transistor (IGBT) or another type of field-effect transistor (FET), such as a Gallium Nitride High-Electron-Mobility Transistor (GaN HEMT) or a Silicon Carbide High-Electron-Mobility Transistor (SiC HEMT). A high-side body diode 115 is connected across each of the high-side switches 114. The high-side body diode 115 defines a cathode that is connected to the DC high node 104h, and an anode that is connected to the corresponding one of the three output nodes 112a, 112b, 112c. The high-side body diode 115 may be a stand-alone device. Alternatively, the high-side body diode 115 may represent a functional effect of the associated high-side switch 114 that is connected thereacross.

Each of the three phase drivers 110a, 110b, 110c also includes a low-side switch 116 configured to selectively conduct current between the DC low node 104l and a corresponding one of the three output nodes 112a, 112b, 112c. The high-side switches 114 may each include a metal-oxide-semiconductor field-effect transistor (MOSFET). However, other types of switching devices may be used, such as an insulated-gate bipolar transistor (IGBT) or another type of field-effect transistor (FET), such as a Gallium Nitride High-Electron-Mobility Transistor (GaN HEMT) or a Silicon Carbide High-Electron-Mobility Transistor (SiC HEMT). A low-side body diode 117 is connected across each of the low-side switches 116. The low-side body diode 117 defines a cathode that is connected to the corresponding one of the three output nodes 112a, 112b, 112c, and an anode that is connected to the DC low node 104l. The low-side body diode 117 may be a stand-alone device. Alternatively, the low-side body diode 117 may represent a functional effect of the associated low-side switch 116 that is connected thereacross.

The second motor drive system 100 also includes three phase current sensors 94a, 94b, 94c of the one or more current sensors 94 and which are functionally connected to the controller 80 to enable the controller 80 to measure a current in each of the three phase drivers 110a, 110b, 110c. In some embodiments, and as shown in FIG. 3, each of the three phase current sensors 94a, 94b, 94c detects current through a corresponding one of the low-side switches 116. However, the phase current sensors 94a, 94b, 94c may be configured to detect current at a different location in the second motor drive system 100.

The second motor drive system 100 also includes three position sensors 96a, 96b, 96c of the one or more position sensors 96 and which are functionally connected to the controller 80 to enable the controller 80 to detect a rotational position of the BLDC motor 92. The three position sensors 96a, 96b, 96c may include Hall-effect sensors configured to measure a rotor position of the BLDC motor 92. However, the three position sensors 96a, 96b, 96c may use another type of sensing technique.

The second motor drive system 100 also includes a gate driver 118 that is configured to generate control signals for commanding operation of each of the high-side switches 114 and each of the low-side switches 116. For example, the gate driver 118 may generate pulse-width modulated (PWM) control signals for application to the gates of the high-side switches 114 the low-side switches 116 to command each of the switches 114, 116 to selectively conduct current.

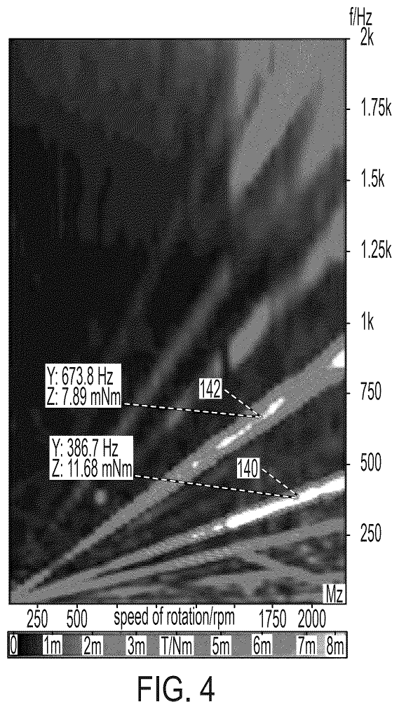

FIG. 4 shows a graph illustrating noise generated by the BLDC motor drive system as a function of speed of rotation of the BLDC motor and showing 12^{th} and 24^{th} harmonic noise. FIG. 4 includes a first point 140 on a diagonal line representing the 12^{th} harmonic noise and at a frequency of 386.7 Hz and where the noise has a magnitude of 11.68 millinewton-meters (mNm). FIG. 4 also includes a second point 142 on a diagonal line representing the 24^{th} harmonic noise and at a frequency of 673.8 Hz and where the noise has a magnitude of 7.89 mNm. As shown on FIG. 4, the 12^{th} and 24^{th} harmonic noise each are most intense for motor speeds greater than about 1400 revolutions per minute (rpm).

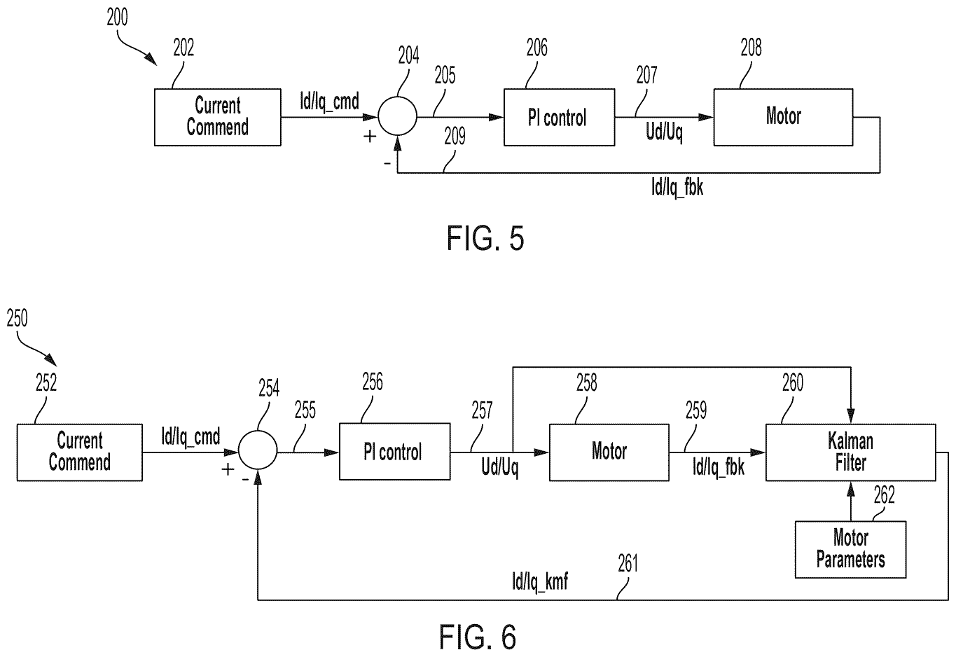

FIG. 5 shows a schematic block diagram of a first motor control system 200 for a BLDC motor drive. The first motor control system 200 may implement a conventional design that takes a first current command 202, which may also be called i_{d}/i_{q}_cmd, and generates a first voltage command 207 based on the first current command 202 and for application to a first motor 208, such as the BLDC motor 92. For example, the inverter 90 may be controlled to apply a voltage in accordance with the first voltage command 207, thereby inducing a current in the stator windings 98a, 98b, 98c of the BLDC motor 92 and which tracks the first current command 202. The first current command 202 and the first voltage command 207 may each include d-axis and q-axis components.

As shown, the first motor control system 200 includes a first subtractor 204 that is configured to generate a first current difference signal 205, as a difference between the first current command 202 and a first feedback current signal 209, which may be called i_{d}/i_{q}_fbk. In some embodiments, the first feedback current signal 209 may also include d-axis and q-axis components. The first feedback current signal 209 may be generated based on actual currents in the stator windings 98a, 98b, 98c. For example, the first feedback current signal 209 may be computed based on measurements from the phase current sensors 94a, 94b, 94c. The first motor control system 200 also includes a first proportional-integral (PI) controller 206 that computes the first voltage command 207 based on the first current difference signal 205.

FIG. 6 shows a schematic block diagram of a second motor control system 250 for a BLDC motor drive, in accordance with the present disclosure. The second motor control system 250 may be similar or identical to the first motor control system 200, except for differences as described herein. The second motor control system 250 takes a second current command 252, which may also be called i_{d}/i_{q}_cmd, and generates a second voltage command 257 based on the second current command 252 and for application to a second motor 258, such as the BLDC motor 92. For example, the inverter 90 may be controlled to apply a voltage in accordance with the second voltage command 257, thereby inducing a current in the stator windings 98a, 98b, 98c of the BLDC motor 92 and which tracks the second current command 252. The second current command 252 and the second voltage command 257 may each include d-axis and q-axis components.

As shown, the second motor control system 250 includes a second subtractor 254 that is configured to generate a second current difference signal 255, as a difference between the second current command 252 and a modified feedback current signal 261, which may be called i_{d}/i_{q}_kmf. The modified feedback current signal 261 may also include d-axis and q-axis components. The second motor control system 250 also includes a Kalman filter 260 that is configured to generate the modified feedback current signal 261 based on a second feedback current signal 259 representing motor current. The second feedback current signal 259 may be generated based on actual currents in the stator windings 98a, 98b, 98c. For example, the second feedback current signal 259 may be computed based on measurements from the phase current sensors 94a, 94b, 94c. The second motor control system 250 also includes a second proportional-integral (PI) controller 256 that computes the second voltage command 257 based on the second current difference signal 255. The second proportional-integral (PI) controller 256 may be similar or identical to the first PI controller 206 of the first motor control system 200.

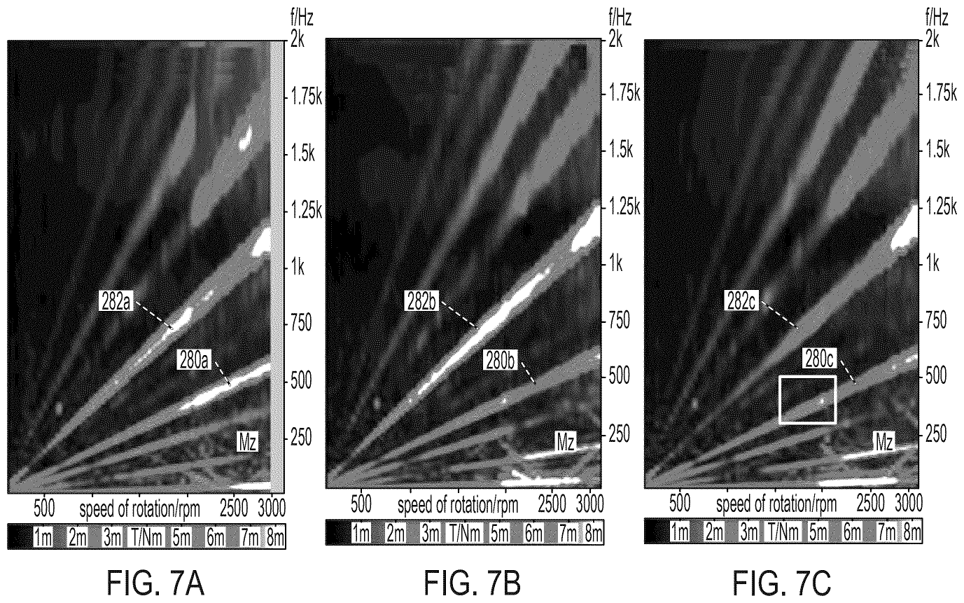

FIG. 7A shows a graph illustrating noise generated by the BLDC motor drive system as a function of speed of rotation of the BLDC motor and without the Kalman filter being enabled. FIG. 7A shows relatively high intensity noise for both the 12^{th} harmonic at 280a and for the 24^{th} harmonic at 282a. FIG. 7B shows a graph illustrating noise generated by the BLDC motor drive system as a function of speed of rotation of the BLDC motor and with the Kalman filter being enabled. FIG. 7B shows the 12^{th} harmonic with drastically reduced noise intensity at 280b, but the 24^{th} harmonic with increased noise intensity at 282b. FIG. 7C shows a graph illustrating noise generated by the BLDC motor drive system as a function of speed of rotation of the BLDC motor and with the Kalman filter being enabled and tuned to compensate for the 24^{th} harmonic noise. As shown, the Kalman filter with tuning to compensate for the 24^{th} harmonic noise shows the 12^{th} harmonic with drastically reduced noise intensity at 280c and also the 24^{th} harmonic with drastically reduced noise intensity at 282b.

The present disclosure employs a Kalman Filter. First, a system model may be developed. Classical control theory may be used for current control, while the Kalman filter is based on modern control theory. Direct-axis voltage u_{d} and quadrature-axis voltage u_{q} may be described by equation set (1):

$${u}_{d} = {R}_{s} * {i}_{d} + {L}_{d} * \frac{{di}_{d}}{dt} - {ω}_{e} * {L}_{q} * {i}_{q} \qquad ( 1 )$$

$${u}_{q} = {R}_{s} * {i}_{q} + {L}_{q} * \frac{{di}_{q}}{dt} - {ω}_{e} * ( {L}_{d} * {i}_{d} + ψ )$$

where Rₛ is stator winding resistance, i_{d} is d-axis current, L_{d} is d-axis inductance, ωₑ is electrical speed (in radians per second), L_{q} is q-axis inductance, i_{q} is q-axis current, and ψ is flux linkage of the motor.

Decoupling equation set (1) and performing a Laplace transform provides a transfer function G(s) as set forth in equation (2):

$$G ( s ) = \frac{1 / L}{s + R / L} \qquad ( 2 )$$

The transfer function G(s) may be transformed to a set of state equations, as described in equation set (3):

$$\dot{X} = A * X + B * U \qquad ( 3 )$$

$$Y = CX + D$$

where \dot{X} is a predicted state model, and X is a state vector including values representing a current state of the motor control system, U is an input vector including measurable (and controllable) inputs to the motor control system, and Y is a measurement vector that is based on the state vector X. A, B, C, and D are configurable matrices that are configured to model the motor control system. A is a state transition model and may be computed as A=−R/L. B is a control-input model and may be computed as B=1/L. C is an observation model and may be equal to 1. D is a disturbance vector that represents observation noise and may be equal to 0.

The system model may be discretized for time steps k having a time duration T=0.0000625*2 s, as described in equation set (4):

$$X ( k + 1 ) = A * X ( k ) + B * T * U ( k ) \qquad ( 4 )$$

$$Y ( k ) = CX ( k ) + D$$

where X(k+1) is a predicted state vector at time step k+1, A is computed as A=1−T*R/L; B is computed as B=T/L; C is equal to 1; and D is equal to 0.

To simplify the calculation, the decoupled voltage may be used to compute a d-axis modified voltage u_{d_kmf} and a q-axis modified voltage u_{q_kmf}, as set forth in equation set (5):

$${u}_{d \_ kmf} = {u}_{d} + {ω}_{e} * {L}_{q} * {i}_{q} \qquad ( 5 )$$

$${u}_{q \_ kmf} = {u}_{q} - {ω}_{e} * ( {L}_{d} * {i}_{d} * ψ )$$

A Kalman filter may be used to compute the modified feedback current signal 261 having a d-axis component i_{d_x} and a q-axis component i_{q_x}. The Kalman filter may include a first step, as set forth in equation set (6):

$${i}_{d \_ x} = {i}_{d \_ y} * ( 1 - T * \frac{R}{L} ) + \frac{T}{L} * {u}_{d \_ kmf} \qquad ( 6 )$$

$${i}_{q \_ x} = {i}_{q \_ y} * ( 1 - T * \frac{R}{L} ) + \frac{T}{L} * {u}_{q \_ kmf}$$

The Kalman filter may also include a second step, as set forth in equation (7):

$$P = {( 1 - T * \frac{R}{L} )}^{2} * P + Q \qquad ( 7 )$$

where P represents an estimate covariance matrix, and Q is a process noise covariance matrix that represents costs associated with a given state.

The Kalman filter may also include a third step, as set forth in equation (8):

$${m}_{n} = P * \frac{C}{( {C}^{2} * P + R )} \qquad ( 8 )$$

where mₙ is a multivariate with n components and represents the gain of Kalman filter, and R is a measurement noise covariance matrix that represents costs associated with a control effort.

The Kalman filter may also include a fourth step, as set forth in equation set (9):

$${i}_{d \_ y} = {i}_{d \_ x} + {m}_{n} * ( {i}_{d \_ M - C} * {i}_{d \_ x} ) \qquad ( 9 )$$

$${i}_{q \_ y} = {i}_{q \_ x} + {m}_{n} * ( {i}_{q \_ M - C} * {i}_{q \_ x} )$$

The Kalman filter may also include a fifth step, as set forth in equation (10):

$$P = ( 1 - {m}_{n} * C ) * P \qquad ( 10 )$$

The Kalman filter may include a filter coefficient Q/R, which may be adjusted based on a modulation index of the inverter 90. The filter coefficient Q/R may also be called a filter depth of the Kalman filter. The modulation index may represent a duty cycle of the high-side switches 114 in each of the three phase drivers 110a, 110b, 110c. The modulation index may have a value between 0 and 1, with 0 representing the high-side switches 114 being in a non-conductive state for an entirety of each switching period, and with a modulation index of 1 representing the high-side switches 114 being in a conductive state for an entirety of each switching period. A modulation index of 0.5 would represent the high-side switches 114 being in the conductive state for half of each switching period.

The filter coefficient (Q/R) of the Kalman filter 260 may be set to a maximum value for low values of the modulation index, such as modulation index values that are less than a first predetermined index value Index1. The filter coefficient (Q/R) of the Kalman filter 260 may be set to a minimum value for high values of the modulation index, such as modulation index values that are greater than a second predetermined index value Index2. The filter coefficient (Q/R) of the Kalman filter 260 may be set to a value between the minimum and maximum values and proportionally based on a value of the modulation index between the first predetermined index value Index1 and the second predetermined index value Index2. For example, the filter coefficient may be adjusted as set forth in table 1, below:

TABLE 1

| Modulation Index | Q/R |
|---|---|
| 0 to Index1 | Maximum |
| Index1 to Index2 | Max. → Min. |
| Index2 to 1 | Minimum |

Relatively high values of the modulation index, such as values greater than 0.8, correspond to current being conducted through the low-side switches 116 for a very short period of time, which may be too fast to be accurately sampled and measured. Thus, different modes may be used for determining an estimated motor current based on measured phase currents, based on the modulation index. For example, a first mode that uses values from all of the phase current sensors 94a, 94b, 94c, may be implemented for computing the estimated motor current when the modulation index has a value less than the first predetermined index value Index1. A second mode that uses measured phase currents from fewer than all of the phase current sensors 94a, 94b, 94c may be implemented when the modulation index has a value greater than the first predetermined index value Index1. In the second mode, for example, values from two of the of the phase current sensors 94a, 94b, 94c, may be used directly, while a value from a third sensor may be estimated based on the two measured phase current sensor values. Kirchhoff's current law (KCL) may be used to estimate the value from a third sensor, which may be estimated based on the two measured phase current sensor values. In some embodiments, a third mode that uses values from only one of the phase current sensors 94a, 94b, 94c, may be implemented for computing the estimated motor current when the modulation index has a value greater than the second predetermined index value Index2.

The second and third modes, using measured phase currents from fewer than all of the phase current sensors 94a, 94b, 94c in order to determine the estimated motor current, may cause inaccuracy in the current measurements. This inaccuracy can be a source of system noise, especially at the 12^{th} and 24^{th} harmonics. Adjusting the filter coefficient Q/R, based on the modulation index of the inverter 90, as described herein, can greatly reduce the system noise at the 12^{th} and 24^{th} harmonics. A maximum value for the filter coefficient Q/R may be used in the first mode, when the modulation index is relatively low and all of the phase current sensors 94a, 94b, 94c are used. This maximum value for the filter coefficient Q/R may reduce an effect of the Kalman filter 260 during low speed operation, when mitigation of harmonic noise is not required.

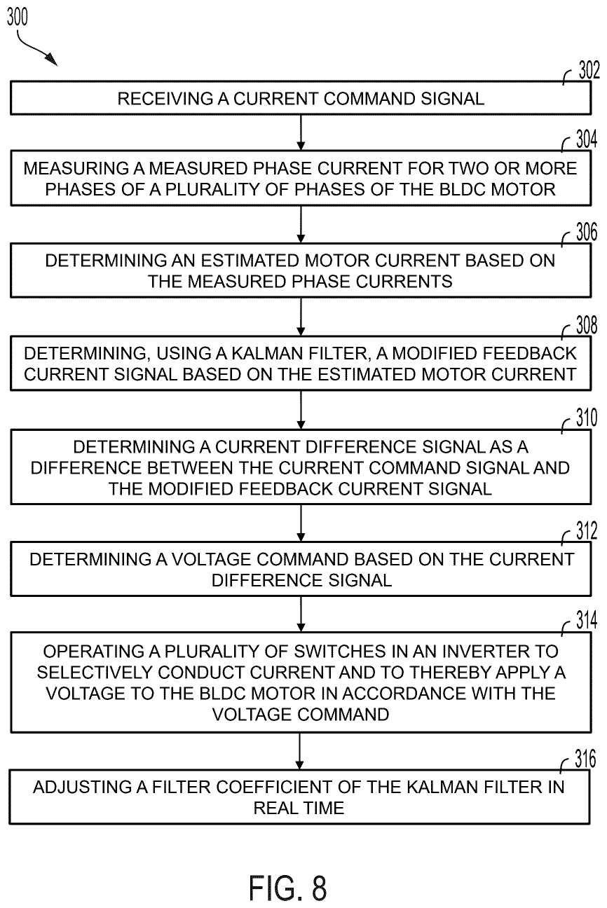

FIG. 8 shows a flow diagram listing steps in a method 300 of operating a motor control system for a brushless direct current (BLDC) motor according to the principles of the present disclosure. The method 300 can be performed by the controller 80 of the present disclosure. As can be appreciated in light of the disclosure, the order of operation within the method is not limited to the sequential execution as illustrated in FIG. 8, but may be performed in one or more varying orders as applicable and in accordance with the present disclosure.

The wherein the BLDC motor is configured to perform at least one of: applying an assist torque to a steering system of a vehicle, or controlling the steering system. However, the method 300 may be used for operating BLDC motors for a variety of other applications.

The method 300 includes, at 302, receiving a current command signal. For example, the processor 82 may execute instructions to implement the second motor control system 250, which receives a current command signal representing the second current command 252. The current command signal may be received from another functional unit, such as a motion controller that may generate the current command signal to cause the BLDC motor 92 to generate a given amount of torque and/or to operate at a given speed. The source of the current command signal may be internal, such as another software module executed by the processor 82. Alternatively, the current command signal may be received from an external source, such as a separate hardware device.

The method 300 also includes, at 304, measuring a measured phase current for two or more phases of a plurality of phases of the BLDC motor. For example, one or more of the three phase current sensors 94a, 94b, 94c may measure corresponding phase currents.

In some embodiments, step 304 may include measuring a current between the output node and one of the DC high node or the DC low node. For example, the three phase current sensors 94a, 94b, 94c may each be arranged to measure the current between the DC low node and a corresponding one of the output nodes 112a, 112b, 112c, as shown in FIG. 3. However, the three phase current sensors 94a, 94b, 94c may have a different configuration. For example, step 304 may include measuring one or more of the phase currents between one of the output nodes 112a, 112b, 112c and a corresponding one of the stator windings 98a, 98b, 98c.

The method 300 also includes, at 306, determining an estimated motor current based on the measured phase current. For example, the processor 82 may execute instructions to determine the estimated motor current based on the measured phase current. Step 306 may include filtering, scaling and/or otherwise processing raw data from the one or more of the three phase current sensors 94a, 94b, 94c in order to determine the estimated motor current. In some embodiments, step 306 may include determining the estimated motor current using two or more different operating modes, depending on a modulation index.

The method 300 also includes, at 308, determining, using a Kalman filter, a modified feedback current signal based on the estimated motor current. For example, the processor 82 may execute instructions to implement the Kalman filter 260 to compute the modified feedback current signal 261.

In some embodiments, the Kalman filter includes configurable matrices having values representing a model of the BLDC motor after dq decoupling. For example, the Kalman filter may be configured in accordance with: \dot{X}=A*X+B*U; and Y=CX+D, where \dot{X} is a predicted state model, X is a state vector including values representing a current state of the motor control system, U represents an input vector, Y represents an output vector, A is a state transition model and is computed as A=−R/L, R is a winding resistance of the BLDC motor, L is an inductance of the BLDC motor, B is a control-input model and is computed as B=1/L, C is an observation model and is equal to 1, and D is a disturbance vector and is equal to 0.

The method 300 also includes, at 310, determining a current difference signal as a difference between the current command signal and the modified feedback current signal. For example, the processor 82 may execute instructions to implement the second subtractor 254 to compute the second current difference signal 255 representing a difference between the second current command 252 and the modified feedback current signal 261.

The method 300 also includes, at 312, determining a voltage command based on the current difference signal. In some embodiments, step 312 may further include computing the voltage command using a proportional-integral (PI) controller and based on the current difference signal. For example, the processor 82 may execute instructions to implement the second proportional-integral (PI) controller 256 to compute the second voltage command 257 based on the second current difference signal 255. However, step 312 may use a different computation and/or another technique for determining the voltage command.

The method 300 also includes, at 314, operating a plurality of switches in an inverter to selectively conduct current and to thereby apply a voltage to the BLDC motor in accordance with the voltage command. For example, the processor 82 may execute instructions to send commands to the gate driver 118 and to thereby command operation of each of the high-side switches 114 and each of the low-side switches 116 and to thereby apply the output voltages V_{OUT_a}, V_{OUT_b}, V_{OUT_c}, to the stator windings 98a, 98b, 98c and in accordance with the second voltage command 257.

The method 300 may also include, at 316, adjusting, a filter coefficient of the Kalman filter in real time. For example, the processor 82 may execute instructions to regularly or continuously adjust the filter coefficient based on the modulation index.

In some embodiments, step 316 may further include: setting the filter coefficient to a first preset value in response to the modulation index having a value between zero and a first predetermined index value; setting the filter coefficient to a second preset value in response to the modulation index having a value between a second predetermined index value and 1.0, wherein the second preset value is greater than the first preset value; and setting the filter coefficient to an intermediate value between the first preset value and the second preset value in response to the modulation index having a value between the first predetermined index value and the second predetermined index value. For example, the processor 82 may execute instructions to adjust the filter coefficient as set forth in Table 1 and as described in the present disclosure.

The present disclosure provides method of operating a motor control system for a brushless direct current (BLDC) motor. The method includes: receiving a current command signal; measuring a measured phase current for two or more phases of the BLDC motor; determining an estimated motor current based on the measured phase currents; determining, using a Kalman filter, a modified feedback current signal based on the estimated motor current; determining a current difference signal as a difference between the current command signal and the modified feedback current signal; determining a voltage command based on the current difference signal; and operating a plurality of switches in an inverter to selectively conduct current and to thereby apply a voltage to the BLDC motor in accordance with the voltage command.

In some embodiments, determining the voltage command further includes computing the voltage command using a proportional-integral (PI) controller and based on the current difference signal.

In some embodiments, the Kalman filter includes configurable matrices having values representing a model of the BLDC motor after dq decoupling.

In some embodiments, the Kalman filter is configured in accordance with: \dot{X}=A*X+B*U; and Y=CX+D, where \dot{X} is a predicted state model, X is a state vector including values representing a current state of the motor control system, U represents an input vector, Y represents an output vector, A is a state transition model and is computed as A=−R/L, R is a winding resistance of the BLDC motor, L is an inductance of the BLDC motor, B is a control-input model and is computed as B=1/L, C is an observation model and is equal to 1, and D is a disturbance vector and is equal to 0.

In some embodiments, the method further includes adjusting, in real time, a filter coefficient of the Kalman filter.

In some embodiments, operating each of the plurality of switches in the inverter includes driving each of the plurality of switches to a conductive state an in accordance with a modulation index, and adjusting the filter coefficient of the Kalman filter further includes adjusting the filter coefficient based on the modulation index.

In some embodiments, adjusting the filter coefficient of the Kalman filter based on the modulation index further includes: setting the filter coefficient to a first preset value in response to the modulation index having a value between zero and a first predetermined index value; setting the filter coefficient to a second preset value in response to the modulation index having a value between a second predetermined index value and 1.0, wherein the second preset value is greater than the first preset value; and setting the filter coefficient to an intermediate value between the first preset value and the second preset value in response to the modulation index having a value between the first predetermined index value and the second predetermined index value.

In some embodiments, operating the plurality of switches in the inverter further includes: driving a high-side switch to a conductive state to selectively conduct current between a DC high node and an output node connected to the BLDC motor for a conductive period in each of a plurality of operating periods; and driving a low-side switch to a conductive state after the conductive period in each of the plurality of operating periods to selectively conduct current between the output node and a DC low node, wherein the DC low node and the DC high node have a DC voltage applied therebetween, wherein the conductive period is proportional to a modulation index, and wherein measuring the measured phase currents includes measuring a current between the output node and one of the DC high node or the DC low node.

In some embodiments, determining the estimated motor current based on the measured phase currents further includes changing, based on a modulation index, between a first mode using measured phase currents of all phases of the plurality of phases of the BLDC motor, and a second mode using measured phase currents of fewer than all phases of the plurality of phases of the BLDC motor.

In some embodiments, the BLDC motor is configured to perform at least one of: applying an assist torque to a steering system of a vehicle, or controlling the steering system.

The present disclosure also provides a motor control system for a brushless direct current (BLDC) motor having a plurality of stator windings and defining a plurality of phases. The motor control system includes: a DC power supply including a DC high node and a DC low node, wherein the DC low node and the DC high node have a DC voltage therebetween; an inverter having a plurality of phase drivers each configured to apply a DC power to a corresponding stator winding of the plurality of stator windings via an output node connected to the BLDC corresponding stator winding, wherein each phase driver of the plurality of phase drivers includes: a high-side switch configured to selectively conduct current between the DC high node and the output node, and a low-side switch configured to selectively conduct current between the output node and the DC low node; two or more phase current sensors, each configured to determine a measured phase current in a corresponding phase driver of the plurality of phase drivers; and a controller. The controller is configured to: determine an estimated motor current based on the measured phase currents; determine, using a Kalman filter, a modified feedback current signal based on the estimated motor current; determine a current difference signal as a difference between a current command signal and the modified feedback current signal; determine a voltage command based on the current difference signal; and send a command to the inverter to cause the high-side switch and the low-side switch of the plurality of phase drivers to each selectively conduct current and to thereby apply a voltage to the BLDC motor in accordance with the voltage command.

In some embodiments, determining the voltage command includes the controller being further configured to compute the voltage command using a proportional-integral (PI) controller and based on the current difference signal.

In some embodiments, the Kalman filter includes configurable matrices having values representing a model of the BLDC motor after dq decoupling.

In some embodiments, the Kalman filter is configured in accordance with: \dot{X}=A*X+B*U; and Y=CX+D, where \dot{X} is a predicted state model, X is a state vector including values representing a current state of the motor control system, U represents an input vector, Y represents an output vector, A is a state transition model and is computed as A=−R/L, R is a winding resistance of the BLDC motor, L is an inductance of the BLDC motor, B is a control-input model and is computed as B=1/L, C is an observation model and is equal to 1, and D is a disturbance vector and is equal to 0.

In some embodiments, the controller is further configured to adjust, in real time, a filter coefficient of the Kalman filter.

In some embodiments, sending the command to the inverter causes cause the high-side switch and the low-side switch of the plurality of phase drivers to each be operated in accordance with a modulation index, and adjusting the filter coefficient of the Kalman filter includes the controller further adjusting the filter coefficient based on the modulation index.

In some embodiments, adjusting the filter coefficient of the Kalman filter based on the modulation index includes the controller being further configured to: set the filter coefficient to a first preset value in response to the modulation index having a value between zero and a first predetermined index value; set the filter coefficient to a second preset value in response to the modulation index having a value between a second predetermined index value and 1.0, wherein the second preset value is greater than the first preset value; and set the filter coefficient to an intermediate value between the first preset value and the second preset value in response to the modulation index having a value between the first predetermined index value and the second predetermined index value.

In some embodiments, the command further causes each of the phase drivers of the inverter to: drive the high-side switch to a conductive state to selectively conduct current for a conductive period in each of a plurality of operating periods; and drive the low-side switch to a conductive state after the conductive period in each of the plurality of operating periods. In some embodiments, the conductive period is proportional to a modulation index, and measuring the measured phase currents includes measuring a current between the output node and one of the DC high node or the DC low node.

In some embodiments, determining the estimated motor current based on the measured phase currents further includes changing, based on a modulation index, between a first mode using measured phase currents of all phases of the plurality of phases of the BLDC motor, and a second mode using measured phase currents of fewer than all phases of the plurality of phases of the BLDC motor.

In some embodiments, the BLDC motor is configured to perform at least one of: applying an assist torque to a steering system of a vehicle, or controlling the steering system.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A method of operating a motor control system for a brushless direct current (BLDC) motor, comprising:
receiving a current command signal;
measuring a measured phase current for two or more phases of the BLDC motor;
determining an estimated motor current based on the measured phase currents;
determining, using a Kalman filter, a modified feedback current signal based on the estimated motor current;
determining a current difference signal as a difference between the current command signal and the modified feedback current signal;
determining a voltage command based on the current difference signal; and
operating a plurality of switches in an inverter to selectively conduct current and to thereby apply a voltage to the BLDC motor in accordance with the voltage command.

2. The method of claim 1, wherein determining the voltage command further includes computing the voltage command using a proportional-integral (PI) controller and based on the current difference signal.

3. The method of claim 1, wherein the Kalman filter includes configurable matrices having values representing a model of the BLDC motor after dq decoupling.

4. The method of claim 3, wherein the Kalman filter is configured in accordance with: \dot{X}=A*X+B*U; and Y=CX+D, where \dot{X} is a predicted state model, X is a state vector including values representing a current state of the motor control system, U represents an input vector, Y represents an output vector, A is a state transition model and is computed as A=−R/L, R is a winding resistance of the BLDC motor, L is an inductance of the BLDC motor, B is a control-input model and is computed as B=1/L, C is an observation model and is equal to 1, and D is a disturbance vector and is equal to 0.

5. The method of claim 1, further including adjusting, in real time, a filter coefficient of the Kalman filter.

6. The method of claim 5, wherein operating each of the plurality of switches in the inverter includes driving each of the plurality of switches to a conductive state an in accordance with a modulation index, and
wherein adjusting the filter coefficient of the Kalman filter further includes adjusting the filter coefficient based on the modulation index.

7. The method of claim 6, wherein adjusting the filter coefficient of the Kalman filter based on the modulation index further includes:
setting the filter coefficient to a first preset value in response to the modulation index having a value between zero and a first predetermined index value;
setting the filter coefficient to a second preset value in response to the modulation index having a value between a second predetermined index value and 1.0, wherein the second preset value is greater than the first preset value; and
setting the filter coefficient to an intermediate value between the first preset value and the second preset value in response to the modulation index having a value between the first predetermined index value and the second predetermined index value.

8. The method of claim 6, wherein operating the plurality of switches in the inverter further includes: driving a high-side switch to a conductive state to selectively conduct current between a DC high node and an output node connected to the BLDC motor for a conductive period in each of a plurality of operating periods; and
driving a low-side switch to a conductive state after the conductive period in each of the plurality of operating periods to selectively conduct current between the output node and a DC low node, wherein the DC low node and the DC high node have a DC voltage applied therebetween,
wherein the conductive period is proportional to a modulation index, and
wherein measuring the measured phase currents includes measuring a current between the output node and one of the DC high node or the DC low node.

9. The method of claim 1, wherein determining the estimated motor current based on the measured phase currents further includes changing, based on a modulation index, between a first mode using measured phase currents of all phases of the plurality of phases of the BLDC motor, and a second mode using measured phase currents of fewer than all phases of the plurality of phases of the BLDC motor.

10. The method of claim 1, wherein the BLDC motor is configured to perform at least one of: applying an assist torque to a steering system of a vehicle, or controlling the steering system.

11. A motor control system for a brushless direct current (BLDC) motor having a plurality of stator windings and defining a plurality of phases, comprising:
a DC power supply including a DC high node and a DC low node, wherein the DC low node and the DC high node have a DC voltage therebetween;
an inverter having a plurality of phase drivers each configured to apply a DC power to a corresponding stator winding of the plurality of stator windings via an output node connected to the BLDC corresponding stator winding, wherein each phase driver of the plurality of phase drivers includes: a high-side switch configured to selectively conduct current between the DC high node and the output node, and a low-side switch configured to selectively conduct current between the output node and the DC low node;
two or more phase current sensors, each configured to determine a measured phase current in a corresponding phase driver of the plurality of phase drivers; and
a controller configured to:
determine an estimated motor current based on the measured phase currents;
determine, using a Kalman filter, a modified feedback current signal based on the estimated motor current;
determine a current difference signal as a difference between a current command signal and the modified feedback current signal;
determine a voltage command based on the current difference signal; and
send a command to the inverter to cause the high-side switch and the low-side switch of the plurality of phase drivers to each selectively conduct current and to thereby apply a voltage to the BLDC motor in accordance with the voltage command.

12. The motor control system of claim 11, wherein determining the voltage command includes the controller being further configured to compute the voltage command using a proportional-integral (PI) controller and based on the current difference signal.

13. The motor control system of claim 11, wherein the Kalman filter includes configurable matrices having values representing a model of the BLDC motor after dq decoupling.

14. The motor control system of claim 13, wherein the Kalman filter is configured in accordance with: \dot{X}=A*X+B*U; and Y=CX+D, where \dot{X} is a predicted state model, X is a state vector including values representing a current state of the motor control system, U represents an input vector, Y represents an output vector, A is a state transition model and is computed as A=−R/L, R is a winding resistance of the BLDC motor, L is an inductance of the BLDC motor, B is a control-input model and is computed as B=1/L, C is an observation model and is equal to 1, and D is a disturbance vector and is equal to 0.

15. The motor control system of claim 11, wherein the controller is further configured to adjust, in real time, a filter coefficient of the Kalman filter.

16. The motor control system of claim 15, wherein sending the command to the inverter causes cause the high-side switch and the low-side switch of the plurality of phase drivers to each be operated in accordance with a modulation index, and
wherein adjusting the filter coefficient of the Kalman filter includes the controller further adjusting the filter coefficient based on the modulation index.

17. The motor control system of claim 16, wherein adjusting the filter coefficient of the Kalman filter based on the modulation index includes the controller being further configured to:
set the filter coefficient to a first preset value in response to the modulation index having a value between zero and a first predetermined index value;
set the filter coefficient to a second preset value in response to the modulation index having a value between a second predetermined index value and 1.0, wherein the second preset value is greater than the first preset value; and
set the filter coefficient to an intermediate value between the first preset value and the second preset value in response to the modulation index having a value between the first predetermined index value and the second predetermined index value.

18. The motor control system of claim 16, wherein the command further causes each of the phase drivers of the inverter to:
drive the high-side switch to a conductive state to selectively conduct current for a conductive period in each of a plurality of operating periods; and
drive the low-side switch to a conductive state after the conductive period in each of the plurality of operating periods,
wherein the conductive period is proportional to a modulation index, and
wherein measuring the measured phase currents includes measuring a current between the output node and one of the DC high node or the DC low node.

19. The motor control system of claim 11, wherein determining the estimated motor current based on the measured phase currents further includes changing, based on a modulation index, between a first mode using measured phase currents of all phases of the plurality of phases of the BLDC motor, and a second mode using measured phase currents of fewer than all phases of the plurality of phases of the BLDC motor.

20. The motor control system of claim 11, wherein the BLDC motor is configured to perform at least one of: applying an assist torque to a steering system of a vehicle, or controlling the steering system.
